(19) United States
(12) Patent Application Publication
(10) Pub. No.: US 2007/0043706 A1
(43) Pub. Date: Feb. 22, 2007

(54) Search history visual representation

(75) Inventors: Eric Paul Burke, Northville, MI (US); Alan Wada, Mountain View, CA (US); Brian Coe, Scotts Valley, CA (US); Mike Kaspar, Campbell, CA (US); Duke Fan, San Jose, CA (US)

Correspondence Address: GREENBERG TRAURIG, LLP, MET LIFE BUILDING, 200 PARK AVENUE, NEW YORK, NY, 10166, US

(73) Assignee: Yahoo! Inc., Sunnyvale, CA (US)

(21) Appl. No.: 11/207,676

(22) Filed: Aug. 18, 2005

(51) Int. Cl. G06F 17/30

(52) U.S. Cl. 707/3

(57) ABSTRACT

A search entry system and method of search entry where the search terms and type of search to be performed can be selected from entries in a search history query log. A search system can include one or more entry modules, which may include a query window configured to accept a search query. The search system can also be configured to display the contents of the search history query log. The search history query log can be configured to store the query terms submitted in a prior search and a type of search conducted for the corresponding query. The search history query log can include identical queries having different search types. A user can select a search query from the displayed search history to retrieve a query and corresponding search type. The user can submit the retrieved query and initiate a search of the same type associated with the query.

### BACKGROUND OF THE DISCLOSURE

In a content retrieval system, a user makes a request for content and receives content matching that request. The user can be a human user interacting with a user interface of a computer that processes the requests and/or forwards the requests to other computer systems. The user could also be another computer process or system that generates the request programmatically. In the latter instance, it is likely that the requesting computer user will also programmatically process the results of the request, but it might instead be the case that a computer user makes a request and a human user is the ultimate recipient of the response, or even the opposite, where a human user makes a request and a computer user is the ultimate recipient of the response.

Content retrieval systems are in common use. One common system in use today uses the network referred to as the Internet, a global internetwork of networks, wherein nodes of the network send requests to other nodes that might respond with content. One protocol usable for content requesting is the HyperText Transport Protocol (HTTP), wherein an HTTP client, such as a browser, makes a request for content referenced by a Uniform Resource Locator (URL) and an HTTP server responds to the requests by sending content specified by the URL. Of course, while this is a very common example, content retrieval is not so limited.

For example, networks other than the Internet might be used, such as token ring, WAP, overlay, point-to-point, proprietary networks, etc. Protocols other than HTTP might be used to request and transport content, such as SMTP, FTP, etc. and content might be specified by other than URLs. Portions of present disclosure are described with reference to the Internet, a global internetwork of networks in common usage today for a variety of applications, but it should be understood that references to the Internet can be substituted with references to variations of the basic concept of the Internet (e.g., intranets, virtual private networks, enclosed TCP/IP networks, etc.) as well as other forms of networks. It should also be understood that the present disclosure might operate entirely within one computer or one collection of computers, thus obviating the need for a network.

The content itself could be in many forms. For example, some content might be text, images, video, audio, animation, program code, data structures, formatted text, etc. For example, a user might request content that is a page having a news story (text) and an accompanying image, with links to other content (such as by formatting the content according to the HyperText Markup Language (HTML) in use at the time).

HTML is a common format used for pages or other content that is supplied from an HTTP server. HTML-formatted content might include links to other HTML content and a collection of content that references other content might be thought of as a document web, hence the name “World Wide Web” or “WWW” given to one example of a collection of HTML-formatted content. As that is a well-known construct, it is used in many examples herein, but it should be understood that unless otherwise specified, the concepts described by these examples are not limited to the WWW, HTML, HTTP, the Internet, etc.

A supplier of content might determine the interests of its users and provide relevant content, such as current news, sports, weather, search services, calendaring, messaging, information retrieval and the like. Content might be in the form of pages that are static (i.e., existing prior to a request for the page), dynamic (i.e., generated in response to a request) or partially static, partially dynamic. Thus, a news report about an event in a particular city might exist as a static page, but that same content might also be generated dynamically in response to a request, taking into account the context of the content and/or demographics of the user making the request.

As an example of a dynamically generated page, if the news report was being viewed by a user known to live in city in which the event is to occur, the resulting page might include information about how to drive to the location of the event or to purchase tickets, however if the user is known to live far from that city, the resulting page might include information about the weather in that remote city and how to purchase an airline ticket to that city.

A user may make a request for content by entering a destination address, such as a URL, of a location having the desired content. Additionally, a user may request content by linking to a site or page having the desired content and information.

A user may have no prior knowledge of the location or destination having desired content or a link to desired content. A user may search for desired content or search for links to desired content by accessing one or more locations operated by search providers and running one or more search applications made available by the search provider. For example, a user may access a known URL or destination made available by a search provider. A web browser application may provide a link to a location of such a search provider to facilitate searches.

A user may navigate to the search provider's site and enter one or more search terms in a user interface, which is typically a text entry box, and submit the query to the search application. The application provided by the search provider can then return one or more links to one or more locations having content related to the search query.

To further facilitate use of their services, some search providers now offer “search toolbar” add-ons for Web browser programs. A search toolbar typically provides a text box into which the user can type a query and a “Submit” button for submitting the query to the search provider's server. Once installed by the user, the search toolbar is generally visible no matter what page the user is viewing, enabling the user to enter a query at any time without first navigating to the search provider's Web site. Searches initiated via the toolbar are processed in the same way as searches initiated at the provider's site; the only difference is that the user is spared the step of navigating to the search provider's site.

### BRIEF SUMMARY OF THE DISCLOSURE

In a search system according to embodiments of the present invention, search entry can be performed using a user interface that presents search terms and type of search to be performed to be selected from entries in a search history query log. A search system can include one or more entry modules, which may include a query window configured to accept a search query. The search system can also be configured to display the contents of the search history query log. The search history query log can be configured to store the query terms submitted in a prior search and a type of search conducted for the corresponding query. The search history query log can include identical queries having different search types. A user can select a search query from the displayed search history to retrieve a query and corresponding search type. The user can submit the retrieved query and initiate a search of the same type associated with the query, where a type can include such categories as web sites, images, video, shopping, finance, and the like.

The disclosure includes a method for presenting a search history, including receiving a request for search history contents and presenting at least a portion of search history contents as one or more search queries and a visual representation of a search type associated with each of the search queries.

The disclosure also includes a method of submitting a search query, including receiving a request for search history contents, displaying at least one previously submitted query, displaying a visual representation of a search type associated with the at least one previously submitted query, receiving a selection from the at least one previously submitted query as the search query, and submitting the search query to initiate a search of the associated search type for the search query.

The search system can be implemented in software, hardware, firmware, or a combination thereof. Computer readable medium might be provided having stored thereon instructions configured to cause presentation of a search history. The instructions include program code for receiving a request for search history contents, and program code for presenting at least a portion of search history contents as one or more search queries and a visual representation of a search type associated with each of the search queries.

An apparatus for presenting a search history is described herein, including a query log configured to store at least one query, a search type log configured to store a search type associated with each of the at least one query, a query log output module configured to output at least a portion of the query log, and a search type output module configured to output a visual representation of at least one search type associated with the portion of the query log.

The benefits and advantages of the various methods and apparatus can be more fully appreciated by reference to the detailed description and accompanying drawings that follow.

### BRIEF DESCRIPTION OF THE DRAWINGS

The features, objects, and advantages of embodiments of the disclosure will become more apparent from the detailed description set forth below when taken in conjunction with the drawings, in which like elements bear like reference numerals.

FIG. 1 is a functional block diagram of an embodiment of an information retrieval and communication network including a client system having search history visual representation.

FIG. 2 is a functional block diagram of an embodiment of an information retrieval and communication system including a search client.

FIG. 3 is a functional block diagram of an embodiment of a search client having search history configured for visual representation.

FIG. 4 is an example of a screen image of a graphical user interface illustrating an embodiment of search history visual representation.

FIG. 5 is a flowchart of an embodiment of a method of configuring a search history with visual representations.

### DETAILED DESCRIPTION OF THE DISCLOSURE

A search entry system is typically configured to allow a user to select a particular search type. The search type can be selected, for example, from a predetermined list of search types or categories of searches. Typical search types include web searches, image searches, news searches, product searches, shopping searches, directory searches, regional searches, finance related searches, and the like, or some combination of types or categories. In some implementations, search type is entirely or partly dependent on the context in which the user entered a query. For example, a search entered on a portal web page's search text box about movies might be considered of a different type of search than a search entered in the search text box of a portal web page for sports.

In an embodiment of a search entry system that is configured to operate in conjunction with a browser application, such as an Internet browser application running on a computer, the search entry system may perform a default search type, and may be configured to perform other search types based on user selections. For example, a search entry system may be configured to display a selection of buttons corresponding to different search types. Upon selection of one of the search types, the search entry system may be configured to perform the selected type of search for submitted queries.

The dynamic nature of content available from a network of communication devices promotes periodic submission of the same, or similar, queries to update search query results and maintain or update links and locations of relevant content sources. Content available over the network may be dynamic due to the nature of the content, such as weather, news, or sports scores. Content available over the network may also be dynamic due to updating of available content sources, including revisions of existing content sources, additions of new relevant content sources, and deletion of previously available content sources.

The dynamic nature of content available over a network may result in a user of a communication device repeatedly submitting the same or very similar search queries. Additionally, the user may repeatedly submit the same query for differing search types.

Methods and apparatus are disclosed that facilitate the resubmission of search queries for particular search types. A search history can include a query log configured to store previously submitted queries and a search type log that is configured to store the type of search corresponding to each stored query. In one embodiment, identical queries having different search types are considered distinct entries within the search history.

The search entry system can be configured to selectively display at least a portion of the contents of the search history. Some or all of the contents of the query log can be displayed accompanied by the additional search dimension provided by the corresponding search type retrieved from the search type log. In one embodiment, the corresponding search type for a query can be presented visually. For example, an icon depicting the search type can accompany each displayed query. In another embodiment, a query can be displayed in a particular font, color or with a background color or background pattern corresponding to a particular search type.

The user can select a query from the displayed search history and submit the query as a new query. The new query is then submitted having the same search type as the search stored in the search type log that is selected.

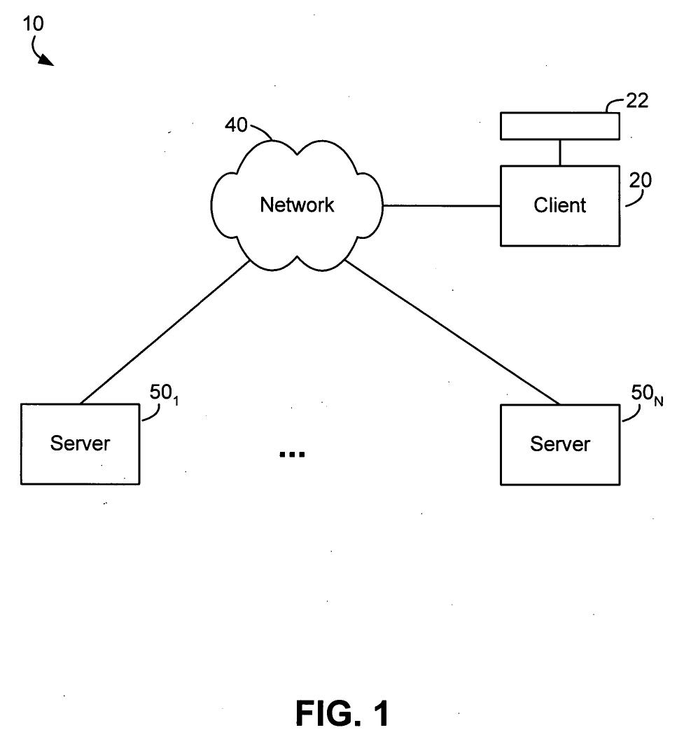

FIG. 1 illustrates a general overview of an embodiment of an information retrieval and communication network 10 including a client system 20 according to an embodiment of the present disclosure. In computer network 10, client system 20 is coupled through a network 40 to any number of server systems 50₁ to 50_{N}. The network 40 can be, for example, the Internet, or other communication network, such as a local area network (LAN), wide area network (WAN), and the like, or some other manner of interconnecting communication devices. As will be described herein, client system 20 is configured according to the present disclosure to communicate with any of server systems 50₁ to 50_{N}, e.g., to access, receive, retrieve and display media content and other information such as web pages.

Several elements in the system shown in FIG. 1 include conventional, well-known elements that need not be explained in detail here. For example, client system 20 could include a desktop personal computer, workstation, laptop, personal digital assistant (PDA), cell phone, or any WAP-enabled device or any other computing device capable of interfacing directly or indirectly to the network 40. Client system 20 typically runs a network interface application, which can be, for example, a browsing program such as Microsoft's Internet Explorer™ browser, Netscape Navigator™ browser, Mozilla™ browser, Opera™ browser, or a WAP-enabled browser in the case of a cell phone, PDA or other wireless device, or the like. The network interface application can allow a user of client system 20 to access, process and view information and pages available to it from server systems 50₁ to 50_{N} over Internet 40.

Client system 20 also typically includes one or more user interface devices 22, such as a keyboard, a mouse, touch screen, pen or the like, for interacting with a graphical user interface (GUI) provided by the browser on a display (e.g., monitor screen, LCD display, etc.), in conjunction with pages, forms and other information provided by server systems 50₁ to 50_{N} or other servers. Although the system is described in conjunction with the Internet, it should be understood that other networks can be used instead of or in addition to the Internet, such as an intranet, an extranet, a virtual private network (VPN), a non-TCP/IP based network, any LAN or WAN or the like.

According to one embodiment, client system 20 and all of its components are operator configurable using an application including computer code run using a central processing unit such as an Intel Pentium™ processor, AMD Athlon™ processor, or the like or multiple processors. Computer code for operating and configuring client system 20 to communicate, process and display data and media content as described herein is preferably downloaded and stored on a processor readable storage medium, such as a hard disk, but the entire program code, or portions thereof, may also be stored in any other volatile or non-volatile memory medium or device as is well known, such as a ROM or RAM, or provided on any media capable of storing program code, such as a compact disk (CD) medium, a digital versatile disk (DVD) medium, a floppy disk, and the like. Additionally, the entire program code, or portions thereof, may be transmitted and downloaded from a software source, e.g., from one of server systems 50₁ to 50_{N} to client system 20 over the Internet, or transmitted over any other network connection (e.g., extranet, VPN, LAN, or other conventional networks) using any communication medium and protocols (e.g., TCP/IP, HTTP, HTTPS, FTP, Ethernet, or other media and protocols).

It should be appreciated that computer code for implementing aspects of the present disclosure can be C, C++, HTML, XML, Java, JavaScript, etc. code, or any other suitable scripting language (e.g., VBScript), or any other suitable programming language that can be executed on client system 20 or compiled to execute on client system 20. In some embodiments, no code is downloaded to client system 20, and needed code is executed by a server, or code already present at client system 20 is executed.

The client 20 can include code configured to operate as a browser application capable of interfacing with one or more of the server systems 50₁ to 50_{N} to search for and retrieve content. The client 20 can be configured to use the browser application to search the one or more server systems 50₁ to 50_{N} for relevant content or links to relevant content. A user, or in general any searcher, at the client 20 can, for example, use the one or more user interface devices 22 to input a query having one or more search terms. The user can then submit the query to one or more server systems 50₁ to 50_{N} where a search process can be executed.

The example of a search process as described herein can be modeled by a searcher presenting to a search system a query with a corresponding search type and receiving a response (search results) indicating the one or more “hits” found. A query can be in the form of search terms or key words (e.g., searching for the latest football scores with a query “football games scores recent”), structured query statements (SQL, Boolean expressions, regular expressions, etc.), by selecting terms from choice lists, following links or a number of other methods currently in use or obvious to one of skill in the art upon review of current literature and/or the present disclosure. The search type can be one from a plurality of search types supported by a searcher, and can include, but is not limited to, web, image, product, directory, news, and the like.

When a query and search type is received by a search system, it processes the search according to the search type and returns one or more “hits”, where a “hit” is the atomic unit handled by the search system. For example, where the search system manages a structured database, the hits are records from the structured database. Where the search system manages documents, such as text documents, image and text documents, image documents, HTML documents, PDF documents, or the like, the atomic unit is the document. It should be understood that the present disclosure is not limited to any particular atomic unit. Furthermore, a structured database is not required.

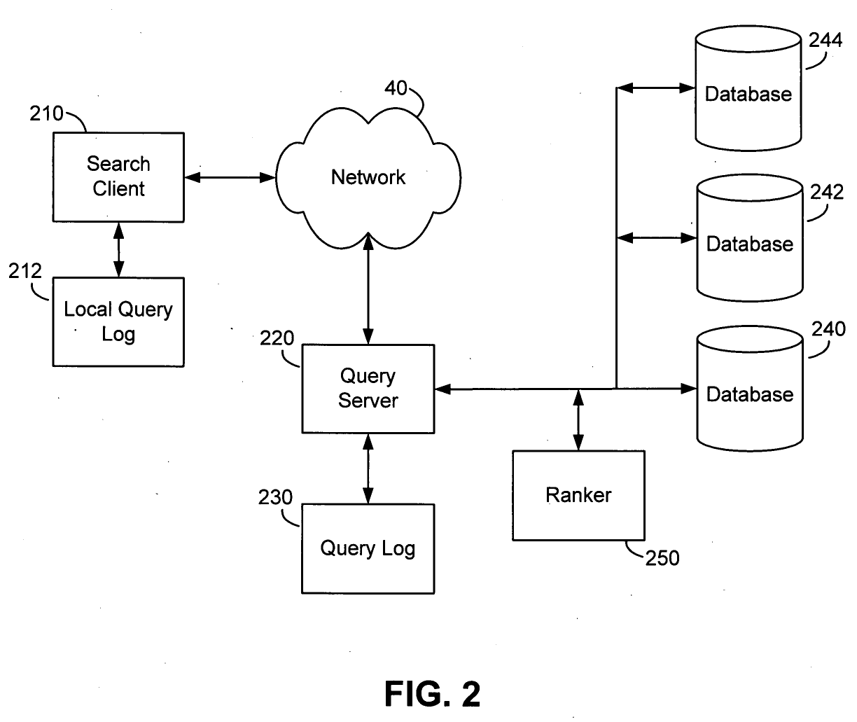

FIG. 2 is a functional block diagram of an embodiment of an information retrieval and communication system 200 including a search client 210 configured for search entry corresponding to at least one of a plurality of search types. The search client 210 can form a portion of the client 20 of FIG. 1. In one embodiment, the search client 210 can be an application running in the client of FIG. 1, and can be configured to run within or in conjunction with another application, such as a browser.

The search client 210 can include, for example, a software program resident on a client 20 or downloaded to the client 20 from a provider, such as from a server 50 coupled to the network 40. The search client 210 can include a library file, such as a Dynamic Link Library (DLL) on the client 20 that creates one or more shells within a browser. Each shell can provide information or functionality loaded, for example, as an ActiveX control or plug-in. The shell can represent the search client 210 as a toolbar within a browser interface. The functionality of the search client 210 may be updated or changed by receiving update information communicated by an appropriate server.

The communication system 200 can include a search client 210 coupled to a network 40, which can be the Internet. A query server 220 can be coupled to the network 220 and can be configured to perform network searches based on received search queries. One or more search provider may configure and provide access to the query server 220. Although only one search client 220 is shown as being connected to the network 40, it is understood that a typical communication system 200 can have a plurality of search clients 220 simultaneously coupled to the network 40 and simultaneously, or otherwise concurrently in communication with the query server 220. Similarly, although FIG. 2 only depicts a single query server 220, multiple query servers 220 can be coupled to the network 40 and can be operated by one or more search providers.

The search client 210 can be configured to submit one or more search queries over the network 40 to the query server 220. Each of the one or more search queries can be associated with a corresponding search type. The search type can be configured to provide an indication of the context of the search, or can be used to provide an indication of the categories or organization of data to be searched.

The query server 220 can be configured to store or otherwise capture the query in an associated query log 230. In the system of communication FIG. 2, the query server 220 can be configured to communicate queries to the query log from one or more search clients 210 coupled to the network 40. The query server 220 can be configured to store the query in conjunction with the search type.

The queries stored in the query log 230 can be used for a variety of functions. For example, the query server 220 may, upon receiving a query, examine the query log 220 to determine if an identical query and search type have recently been processed by the query server 220. If so, the query server 220 may have access to the search results without performing an additional search. Additionally, the contents of the query log can be shared with a ranker 250 configured to collect statistics relating to popular and repeated search terms or search queries for the purposes of generating or updating a search result ranking algorithm.

The query server 220 can also be configured to access and search a database 240 for one or more records from a plurality of databases 240, 242, and 244 matching the search criteria. The query server 220 can be configured to use a predetermined search algorithm to identify the records that are substantially similar in semantics or context to the query and that can be considered matching or otherwise relevant to the query.

The databases 240, 242, and 244 can be generated using, for example, one or more web crawlers that systematically attempt to address and access all available content on the network 40 and catalog the results in a repository in the databases 240, 242, and 244. The results corresponding to a particular search type, for example products, can be cataloged in a corresponding database or portion of a database, for example 240, to facilitate searching. Other search types, for example web, may be configured as super categories, encompassing the results from multiple other search types. The results for such a super category may be stored in multiple databases, for example 240 and 242.

In some embodiments, the same results may be stored in more than one database, for example 242 and 244. While in other embodiments, the results may be stored in only the most relevant database. In a particular embodiment, the query server 220 can be configured to search only those databases corresponding to the search type. While in other embodiments, the query server 220 may be configured to search the various databases 240, 242, and 244, in a hierarchical order that is determined based on the search type.

Regardless of the number of databases searched, the query server 220 can return query results to a ranker 250 that is configure to order the one or more query results into a ranked order according to a predetermined ranking algorithm. The ranking algorithms used by the various search providers may be proprietary and maintained confidentially in order to eliminate the possibility of content providers manipulating the rankings to artificially generate traffic to the site maintained by the content providers.

The ranker 250 can return the search results in ranked order to the query server 220. The query server 220 can then be configured to format and return a portion or all of the ranked search results to the search client 210 via the network 40. The search client 210 can then display or otherwise output the search results to the user.

As discussed above, the search client 210 may be configured to submit queries that are similar or even identical to previously submitted searches. To facilitate the search entry process, the search client 210 can implement a search history representation that can generate all or a portion of the queries and associated search types stored within a search history. The search client 210 can also be configured to generate the search history representation based in part on the contents of one or more query logs, which may include the query log 230 associated with the query server 220, but typically are limited to local query logs (not shown) that are maintained local to the search client 210.

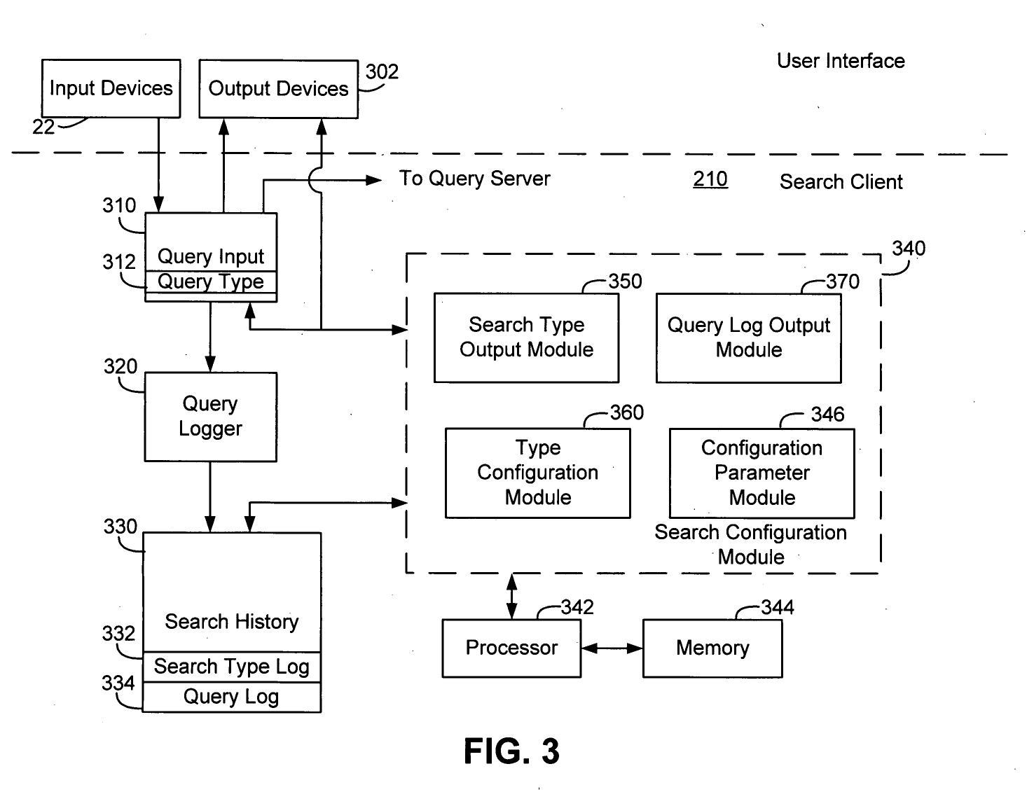

FIG. 3 is a functional block diagram of an embodiment of a search client 210 having search history representation. The search client 210 of FIG. 3, can be the search client of FIG. 2, and can be configured to interface in a networked communication system, such as the system of FIG. 1.

The search client 210 can include a query input 310 configured to receive a query that can include one or more search terms. The query input 310 can be configured to receive a query from one or more user interface devices 22. In one embodiment, the user interface devices 22 can include a keyboard, a mouse, touch screen, pen or the like, for interacting with a graphical user interface (GUI) provided by the browser on a display. In another embodiment, the user interface devices 22 can include a register, port, coupler, or connector configured to interface with another electronic device and configured to receive an electronic representation of the query and couple the query to the query input 310.

The query input 310 can include or otherwise be associated with a query type 312 field that is configured to receive user input indicative of the search type to associate with the query. In one embodiment, the available search types can be displayed as one or more icons that can be selected by the user. In another embodiment, the available search types can be displayed in a drop down menu or some other type of listing. In still another embodiment, the available search types can be displayed as individual links or buttons that can be labeled with the corresponding search type.

The contents of the query input 310, including the query type 312 field, can be coupled to one or more output devices 302, such as a display. Such a configuration can be advantageous when the search client 210 is configured to provide a query input 310 and select a search type in an application configured to operate with a graphical browser interface. In one embodiment, the contents of the query input 310 can be displayed on a display in the form of a text box. The contents of the query type 312 field can be displayed in the text box in the form of an icon, color, background, characters, and the like, or some other indicator corresponding to search type. For example, the text corresponding to the query can be displayed in a color corresponding to the selected search type the user associates with the query.

The user interface devices 22 and output devices 302 typically do not form a part of the search client 210, and may be external to, and interface with, the search client 210. Typically, the user interface devices 22 and output devices 302 are local to the search client 210 but one or more may also be configured to be remote from the search client 210.

For example, a user can use a keyboard to enter a query into the query input 310 and can select a search type using an input device, such as a mouse or pointer. The user can submit the query. The search client 210 can associate audio with each search type and can provide an audio output via an audio output included in the output devices 302. Each search type can be associated with a distinct audio output, or one or more search types can share the same audio output. A query logger 320 can be configured to log the query into a query log 334 portion of a search history 330 when the query is submitted to a query server (not shown). Additionally, the query logger 320 can be configured to store the corresponding search type in a search type log 332 portion of the search history 330. Thus, the query log 330 can be configured to store one or more previously submitted queries and their corresponding search types.

The search history 330 can be associated with a particular client, for example, a local computer on which the search client 210 is resident. In another embodiment, the search history 330 can be unique to a particular user of the client. The search client 210 can be unique to specific users. Each user can have search client 210 functionality that is unique to that user. The user can be associated with a particular account that can be local to the client or that can be administered at a remote server. The user can log into the corresponding account and the search client 210 can be configured according to the client preferences.

In one embodiment, the user account can be local to the client and the client can provide access to the unique search history 330 corresponding to the user when the account is accessed. Alternatively, the user account can be configured remote from the client, for example, a remote server. The user can access or otherwise log into the account and the server can communicate commands to the search client 210 to indicate the particular search history330 corresponding to the user.

The search type log 332 can include multiple search type data fields, with each data field associated with a corresponding entry in the query log 334. In one embodiment, a the search type data field can be a predetermined number of bits appended to an entry in the query log 334.

The query logger 320 in the search client 210 can also be configured to log queries and associated search types that are entered and submitted by the user, via the input devices, to a search input page distinct from the search client 210. For example, the user can use an Internet browser to navigate to a particular site of a search provider and enter a query and associated search type at the interface provided by the search provider. The search client 210 can capture or otherwise trap queries and associated query types submitted at search provider interfaces and can store these captured queries in the query log 334 and associated search type log 332.

The query logger 320 operating within the search client 210 can, for example, analyze tags included in pages or can analyze particular predetermined addresses, such as URL patterns, identifying provider interfaces. The query logger 320 can be configured to capture or otherwise trap the query and associated search types when the query logger 320 detects an identified tag or URL pattern. The tags and URL patterns can be configured within the configuration parameter module 346 and can be updated to change or update the tags and/or URL patterns that identify search provider interfaces.

The search client 210 can also include a search configuration module 340 that is in communication with the query input 310. The search configuration module 340 can be configured to operate in conjunction with the query input 310 prior to submission of the query and search type to the query server.

The search configuration module 340 can include a configuration parameter module 346 that can help define the functionality of the search client 210. The configuration parameter module 346 can define, for example, the available search types, a catalog of icons, colors, or audio sounds associated with each search type, a format of a query string used to identify each search type, a number of entries to display from a client query log, and a number of entries to store in the query log 334 before wrapping. For example, the query log 334 may be configured as a First In First Out (FIFO) buffer, and the depth of the FIFO queue can be configured by a parameter within the configuration parameter module 346.

The parameters stored in the configuration parameter module 346 can be static or can be dynamic. For example, the search client 210 can be updated or changed by receiving update information communicated by an appropriate server. The search client 210 can periodically access a server to see if update information is available and can download update information from the server if it is available. Alternatively, the server may communicate a notification of the availability of update information to the search client 210. The search client may download or otherwise receive the update information from the server by responding to the notification from the server.

The configuration parameter module 346 can be updated to provide for additional search types not previously available. In another example, the configuration parameter module can be updated to delete one or more search types that were previously available. In such a situation, the search configuration module 340 may parse the existing query log 334 and search type log 332 for deprecated search types and replace any identified deprecated search types with a default search type. For example, deprecated search types may be replaced with a search type, “web”, that can be assumed to be a relatively permanent search type. The configuration parameter module 346 can thus ensure that a valid search type will always be submitted.

The configuration parameter module 346 may also be configured to allow the user to access and edit the search history 330. In the embodiment where the search history 330 is unique to the user, the configuration parameter module 346 can be configured to allow the user to display and edit the particular search history 330 corresponding to the user, and may exclude access to the search histories 330 corresponding to other users. The configuration parameter module 346 can, for example, allow the user to manually delete one or more entries within the search history. The configuration parameter module 346 can also be configured to allow the user to clear or otherwise delete the entire contents of the search history 330.

The search configuration module 340 can be configured to present one or more search selections to the user. The search configuration module 340 can be coupled to a processor 342 that is in communication with memory 344. Some or all of the processes and functions performed by the search configuration module 340 can be performed by the processor 342 in conjunction with processor usable instructions stored in memory 344.

The search configuration module 340 can be coupled to the query input 310 and the search history 330. The search configuration module 340 can include a type configuration module 360, search type output module 350 and query log output module 370.

The search configuration module 340 can be configured to receive an input or command, for example, from one or more of the input devices 22 or from the processor 342 that instructs it to output some or all of the contents of the search history 330. For example, the search configuration module 340 can be configured to receive an input from an input device 22 that instructs it to display some or all of the contents of the search history 330 to a user.

In response to the command, the search configuration module 340 can be configured to access the search history 330 to output some or all of the contents to the user. The query log output module can be configured to access the query log and retrieve all or a portion of the contents of the query log 334. In one particular embodiment, the query log output module 370 can be configured to retrieve the contents of the query log 334 up to a predetermined maximum number. In another embodiment, the query log output module 370 can be configured to retrieve all of the contents of the query log 334, but may only perform further operations on a subset of the contents. The query log output module 370 can be configured to format the retrieved query log 334 contents for display or other presentation on one or more output devices 302.

In one embodiment, the query log output module 370 can be configured to format the retrieved contents for display and can filter the results to be less than or equal to a predetermined maximum number of displayed results. The query log output module 370 can format the results for display in, for example, a popup window or scrollable menu that is displayed on an output device 302. The popup window or scrollable menu can be positioned, fore example near, or contiguous with, a displayed query input window.

The query log output module 370 can also be configured to format the results by truncating the retrieved results for purposes of display. In one embodiment, the query log output module 370 can be configured to truncate the retrieved results to less than a predetermined maximum number of display characters.

The search type output module 350 can be configured to retrieve search types from the search type log 332. The search type output module 350 can be configured to retrieve the search types associated with each of the queries retrieved by the query log output module 370. The search configuration module 340 can be configured to track the association of the retrieved search types with the retrieved queries.

In one embodiment where the search type is appended to each query, the search configuration module 340 can be configured to retrieve a query having an appended search type. The search configuration module 340 can parse the data and provide the parsed data to the corresponding output module.

The search type output module 350 can be configured to format the results retrieved from the search type log 332 for display, for example, in the same pop up window or scrollable menu where the queries are displayed. The search type output module 350 can be configured to output a visual representation corresponding to the search type. For example, the search type output module 350 can display an icon, image, color, background, pattern, or the like, or some combination thereof as the output. For example, the search type output module 350 can be configured to output an icon representative of the search type next to each of the displayed queries output by the query log output module 370. In another embodiment, the search type output module 350 can be configured to modify the display color of the displayed queries depending on the search type. In another embodiment, a background color of the displayed queries can be modified based on the search type.

The search entry system, for example a search client 210 running within a browser application, can allow a user to select a query from the displayed queries retrieved from the search history 330. Upon selection of a particular displayed query, the query log output module 350 and search type output module 350 can be configured to populate a query input 310 with the selected query and search type.

A type configuration module 360 can use the search type associated with the selected query to configure the search client 210 for the selected search type. Thus, the type configuration module 360 can configure the search client 210 for the search type as if configured by the user. The search client 210 can then allow the user to continue to enter search terms or other wise edit the query input 310. For example, the search client 210 can allow the user to retrieve a query from the query log 334 and edit the associated search type to associate a new search type prior to submitting the revised query.

The search client 210 of FIG. 3 is described as accessing and searching a search history 330, query log 334, and search type log 332 that is local to the search client 210. In other embodiments, the search configuration module 340 can be configured to search one or more query logs that may be external, or otherwise remote from, the search client 210. For example, the search configuration module 340 can be configured to search a local search history 330 as well as a remote search history for which a destination address is known. The remote search history can be, for example, a search history including a query log associated with a query server, such as the query server shown in FIG. 2.

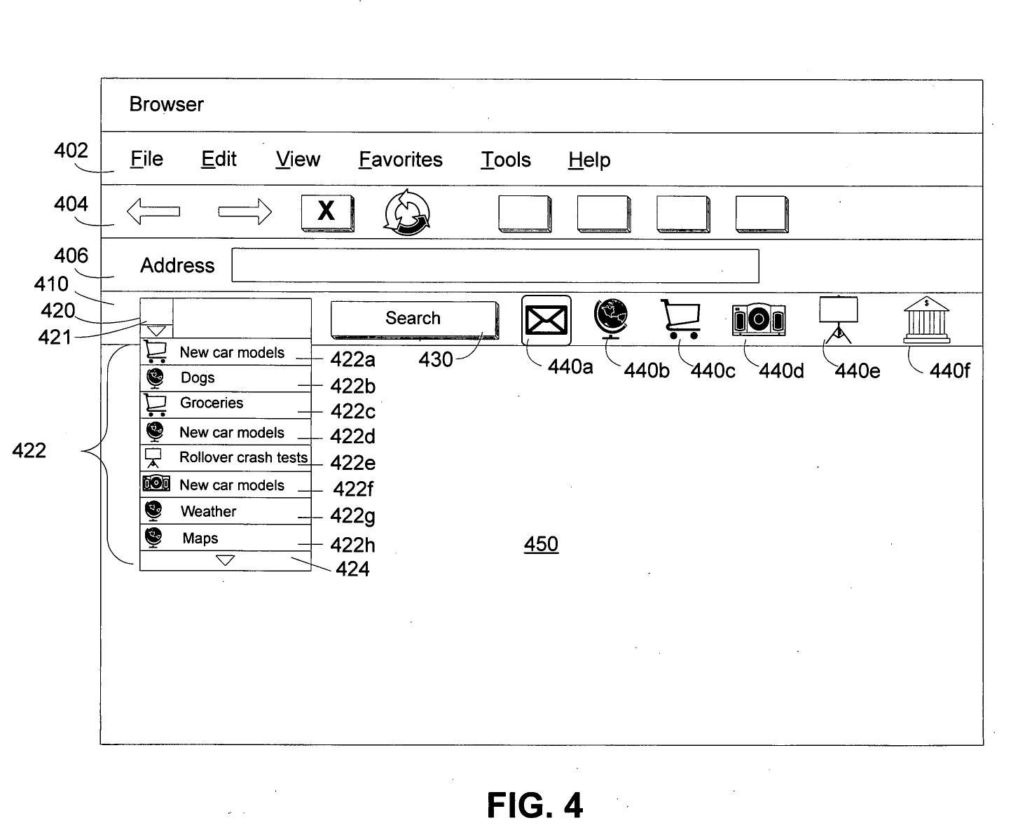

FIG. 4 is an example of a graphical user interface (GUI) 400 illustrating a query input window 410 and search history results 422. The GUI 400 is shown configured as a typical browser interface window. However, the methods and apparatus disclosed herein are not limited to applicability in a browser interface.

The GUI 400 can be configured as a window or graphical interface having one or more control portions 402 and 404, each control portion including one or more buttons or objects that can be selected to provide a corresponding control, action, or operation. The GUI 400 can include an address entry window 406 configured to accept user entry of a destination address.

The GUI 400 can also include a toolbar 410 having a query input window 420 and one or more control buttons or pull down menus 440a-440f that can be accessed by the user. The GUI 400 can also include a content window 450 or portion configured to display content that can be, for example, information displayed as a result of a search.

The user can use an associated input device to enter one or more search terms in the query input window 420. The query input window 420 can correspond to an output of the contents of a query input, such as the query input of FIG. 3. The query input window 420 can also include a search type window 421 that can be configured to display a search type associated with the query.

In one embodiment, the user can select one of the search type control buttons 440a-440f to configure the search for the particular search type. The query and associated search type are stored in a search history when the query is submitted, for example, by selection of a search or submission button 430.

The GUI 400 can be configured to display a portion or all of the contents of a search history, including the particular search type associated with each query. The same query submitted for distinct search types can be considered distinct entries within the search history, although in some instances, the search results can share a large number of common results.

The search history display 422 can include one or more search history entries 422a-422h, and may include one or more navigation control 424 that can be used to navigate among numerous entries if the number of entries exceeds a display window size. Each of the queries displayed in the search history display 422 can include an icon or some other visual representation corresponding to the search type associated with that query. In the embodiment shown in FIG. 4, the icons representing the search type substantially duplicate the image of the search type control buttons 440a-440f from the toolbar 410, but that need not be the case.

Thus, a user examining the search history display 422 is presented a visual indication of the search type associated with each of the entries. Identical search terms may be associated with different search types and may be displayed as distinct entries. For example, the first entry 422a in the search history display 422 is for the search terms “New car models” associated with a search type identified with a shopping cart icon, which may indicate a product or shopping search type. A fourth entry 422d in the search history display 422 may be for the identical search terms “New car models” but may be associated with a web search type, depicted by the globe icon. Furthermore, a sixth entry 422f in the search history display 422 can have identical search terms “New car models” to the first 422a and fourth 422d entries, but may be associated with an image search type, indicated by the camera icon.

The GUI 400 running on a search client can allow the user to select one of the displayed entries from the search history display 422. The selected entry can then appear in the query input window 420. The associated search type identifier can be displayed in the search type window 421. The user can then choose to submit the query or edit the query. For example, the user may edit the search terms or may edit the search type associated with the search terms. If the user submits a query having a search type that is not already stored within the search history, the search client can store the search terms and associated search type in a local search history or other means can store it in a global search history. Submitting the query initiates a search of the search type having the search terms from the query input window 420.

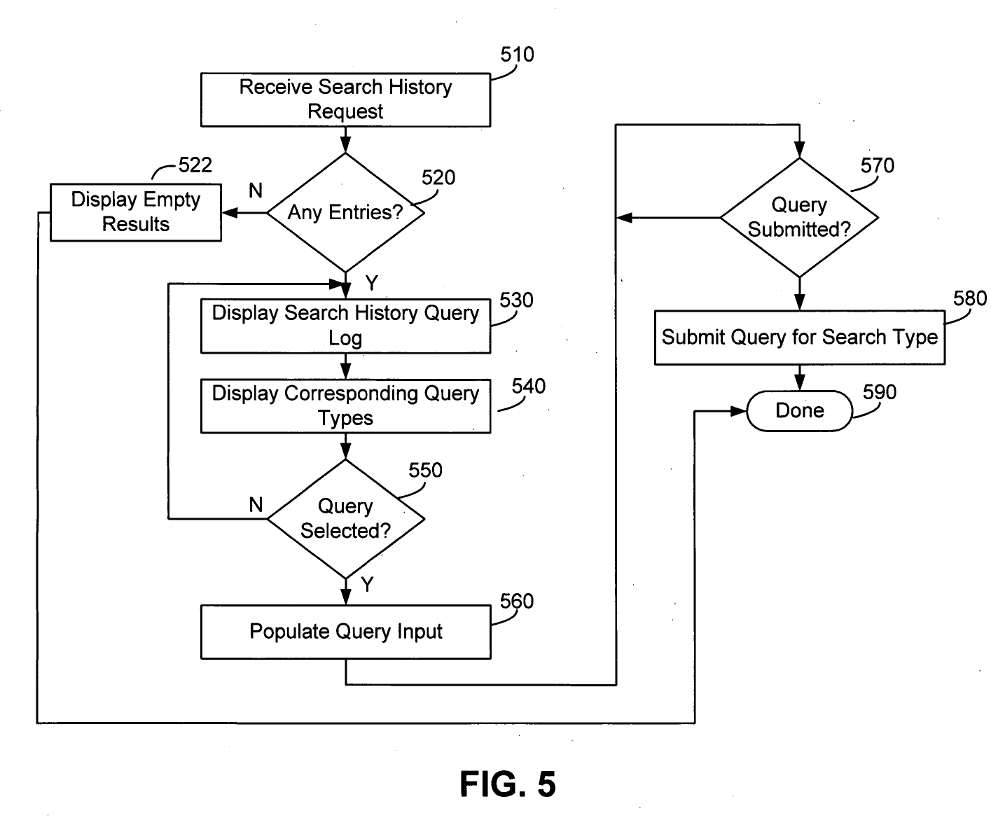

FIG. 5 is a flowchart of an embodiment of a method 500 of search history representation. The method 500 can be performed, for example, by the client 20 of FIG. 1 or the search client 210 of FIG. 3, in conjunction with one or more input and output devices. The method 500 can be, for example, embodied as one or more processor usable instructions stored in one or more storage devices within the search client. The processor can execute the instructions to perform the method 500 in conjunction with external input and output devices.

The method 500 begins at block 510 where the search client receives a search history display request. After receiving the request, the search client then proceeds to decision block 520 to determine if there are any entries in the search history. If not, there is no data to format for display and the search client can proceed to block 522 and display an indicator to the user of no results or an empty search history. The search client can proceed from block 522 to block 590 where it is done.

Returning to decision block 520, if the search client determines that there is at least one entry in the search history, the search client proceeds to block 530 and displays some or all of the contents of the search history query log. The query log contains the search terms for the stored searches.

The search client can be configured to format the search results for output based on the number of search results. If a single search result is generated, the search client may format the search result and display the search result in the search input text window.

If more than one search result is generated, the search client can be configured to generate an output based on some predetermined criteria, such as criteria related to time and date of the logged queries. Additionally, the search client may format the number of results that are output to omit from the output the search results that are older than a predetermined threshold. For example, to minimize the amount of clutter output to a GUI display, the search client may limit the number of search history results to an easily displayed number of results, such as four to ten results. Thus, the search client may select the ten most recent results. Of course, other embodiments may enable the display of more or fewer search history results.

The search client may format the length of the search history results. For example, prior search queries that are stored in the query log may be long query strings having numerous characters. The search client may truncate the query for the purposes of display. The search client will typically not truncate the actual query, rather, the display associated with the query is truncated as part of the formatting. If a user selects the truncated query from the output, the complete query is returned to the input text window.

The search client proceeds to block 540 and displays the corresponding search types associated with each of the displayed queries from the query log. The search client can, for example retrieve the search types from a search type log within the search history. The search client can generate a display based on the search type.

The search client can proceed to decision block 550 to determine if a query is selected from the displayed results. If not, the search client can return to block 530 and continue to display the contents retrieved from the search history.

Returning to decision block 550, if the search client determines that the user selected an entry from the displayed search history, the search client proceeds to block 560 and populates the query input with the selected search terms. The search client can also populate the query input with the corresponding search type or otherwise configure the search for the associated search type.

The search client can proceed to decision block 570 to determine if the query is submitted. The user may choose not to submit the query, for example, to further edit the query. The search client can idle in decision block 570 and await commands from the user to submit the query. Alternatively, the search client may exit the method 500 due to some other command, such as a global escape command, or some other command that overrides the present method 500.

If, at decision block 570 the search client determines that the user submitted the query, the search client proceeds to block 580 and submits the query for the particular search type to the appropriate query server or search provider. The search client then proceeds to block 590 and the method 500 is done.

Methods and apparatus for representation of search history including a visual representation of search type are described above. The methods and apparatus generate a display of search queries stored within a search history and provide a visual indication of the search type associated with each of the queries. Selection and submission of a query from the list of search history entries results in initiation of a search having the same search type.

The methods and apparatus allow a user to quickly identify previous queries that may be related to the present query to facilitate search entry and resubmission or editing of the previously submitted query, including resubmission of the associated search type without the need to explicitly select a search type.

The various illustrative logical blocks, modules, and circuits described in connection with the embodiments disclosed herein may be implemented or performed with a general purpose processor, a digital signal processor (DSP), a Reduced Instruction Set Computer (RISC) processor, an application specific integrated circuit (ASIC), a field programmable gate array (FPGA) or other programmable logic device, discrete gate or transistor logic, discrete hardware components, or any combination thereof designed to perform the functions described herein. A processor may be implemented as a combination of computing devices, for example, a combination of a DSP and a microprocessor, a plurality of microprocessors, one or more microprocessors in conjunction with a DSP core, or any other such configuration.

A software module may reside in RAM memory, flash memory, non-volatile memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor.

The steps of a method, process, or algorithm described in connection with the embodiments disclosed herein may be embodied directly in hardware, in a software module executed by a processor, or in a combination of the two. The various steps or acts in a method or process may be performed in the order shown, or may be performed in another order. Additionally, one or more process or method steps may be omitted or one or more process or method steps may be added to the methods and processes. An additional step, block, or action may be added in the beginning, end, or intervening existing elements of the methods and processes.

The above description of the disclosed embodiments is provided to enable any person of ordinary skill in the art to make or use the disclosure. Various modifications to these embodiments will be readily apparent to those of ordinary skill in the art, and the generic principles defined herein may be applied to other embodiments without departing from the spirit or scope of the disclosure. Thus, the disclosure is not intended to be limited to the embodiments shown herein but is to be accorded the widest scope consistent with the principles and novel features disclosed herein.

What is claimed is:

1. In a computerized search system, wherein users of client computing devices submit queries to one or more search engines and the one or more search engines return search results comprising hits from a corpus over which the searchers are done, a method of facilitating user entry of search queries at the client computing devices, the method comprising:
identifying an initial user context;
using the initial user context as a filter of a search query log, wherein the search query log comprises electronically stored records of prior search queries wherein at least some of the records are of search queries having associated search types;
presenting to the user a set of filtered prior searches from the search query log including an indication of a search type for at least some of the filtered prior searches, thereby prompting the user as to prior searches; and
accepting input from the user representing a current search query developed by the user in response to review of the set of filtered prior searches.

2. The method of claim 1, wherein the indication of the search type comprises an icon.

3. The method of claim 1, wherein the indication of the search type comprises a color.

4. The method of claim 1, wherein the indication of the search type comprises a font used to display the search query.

5. The method of claim 1, wherein the associated search types comprise at least one selected from the group comprising a web search, an image search, a news search, a product search, a directory search, and a region search.

6. The method of claim 1, wherein presenting to the user the set of filtered prior searches comprises:
retrieving one or more prior search queries from the search query log;
retrieving an associated search type for each of the one or more prior search queries;
outputting a representation of the one or more prior search queries; and
outputting, for each of the one or more prior search queries, the indication of the search type associated with the prior search query.

7. A method of submitting a search query, the method comprising:
receiving a request for search history contents;
displaying at least one previously submitted query;
displaying a visual representation of a search type associated with the at least one previously submitted query;
receiving a selection from the at least one previously submitted query as the search query; and
submitting the search query to initiate a search of the associated search type for the search query.

8. The method of claim 7, wherein displaying at least one previously submitted query comprises displaying a list including the at least one previously submitted query.

9. The method of claim 7, wherein displaying the visual representation of the search type comprises displaying the visual representation substantially adjacent the at least one previously submitted query.

10. The method of claim 7, wherein the search type comprises at least one type selected from the group comprising a web search, an image search, a news search, a product search, a directory search, and a region search.

11. The method of claim 7, wherein the visual representation of the search type comprises at least one selected from the group comprising an icon, a color, a background color, a font, and a pattern.

12. A computer readable medium having stored thereon instructions configured to cause presentation of a search history, the instructions comprising:
program code for receiving a request for search history contents; and
program code for presenting at least a portion of search history contents as one or more search queries and a visual representation of a search type associated with each of the search queries.

13. An apparatus for presenting a search history, the apparatus comprising:
a query log configured to store at least one query;
a search type log configured to store a search type associated with each of the at least one query;
a query log output module configured to output at least a portion of the query log; and
a search type output module configured to output a visual representation of at least one search type associated with the portion of the query log.

14. The apparatus of claim 13, wherein the query log output module is configured to output display data of the least a portion of the query log to a display.

15. The apparatus of claim 13, wherein the search type output module is configured to output display data corresponding to the visual representation to a display.

16. The apparatus of claim 13, wherein the search type comprises at least one type selected from the group comprising a web search, an image search, a news search, a product search, a directory search, and a region search.

17. The apparatus of claim 13, wherein the visual representation of the at least one search type comprises at least one selected from the group comprising an icon, a color, a background color, a font, and a pattern.
